(19) United States
(12) Patent Application Publication
(10) Pub. No.: US 2024/0032483 A1
(43) Pub. Date: Feb. 1, 2024

(54) IMPROVED BIODEGRADABLE COMPOSITION AND THEIR METHODS FOR MANUFACTURE

(71) Applicant: PINEHURST ASSOCIATES LIMITED, Hamilton (NZ)

(72) Inventors: Peter Gregory WILSON, Hamilton (NZ); Dawn Alison SMITH, Hamilton (NZ); Regis Sylvain Remi RISANI, Hamilton (NZ); Beatrix THEOBALD, Hamilton (NZ); Maxime BARBIER, Hamilton (NZ)

(21) Appl. No.: 18/256,653

(22) PCT Filed: Dec. 9, 2021
(86) PCT No.: PCT/IB2021/061530

§ 371 Date: Jun. 9, 2023

(30) Foreign Application Priority Data
Dec. 11, 2020 (AU) 2020904620

(51) Int. Cl. A01G 9/029; C05F 1/00; A01G 9/02; C08L 67/02

(52) U.S. Cl. CPC A01G 9/0291; C05F 1/00; A01G 9/021; C08L 67/02; C08L 2201/06; C08L 2205/02

(57) ABSTRACT

Forms of the technology relate to a biodegradable composition including at least one biobased or partially biobased polymer and at least one filler comprising processed organic matter wherein the filler is adapted to provide mechanical stiffness to the composition and/or provide one or more nutrient(s) to soil upon degradation of the composition in soil. The at least one biobased or partially biobased polymer may comprise a combination of polymers including polybutylene succinate (PBS) and polylactic acid (PLA). The filler may include processed organic matter obtained from animal matter, for example animal carcasses. Forms of the technology relate to the use of such a biodegradable composition for the manufacture of a container for plants.

### FIELD OF INVENTION

The present invention relates to improved biodegradable compositions and their methods of manufacture and uses thereof. In one form, the invention relates to an improved biodegradable plant container and/or tray formed from the improved biodegradable composition.

### BACKGROUND TO THE INVENTION

Growing plant seedlings in trays or containers for transplanting has been a popular growth method used in greenhouses, plant nurseries and home gardens.

Typically, plants grown in nurseries are grown in individual containers or trays containing individual plants. The containers and trays are typically single use plastic containers and often difficult to recycle, commonly ending up in the landfill once the plant has been transferred. Further, concerns around biosecurity once the plants leave the nursery lead to containers not being re-used.

Biodegradable pot plant containers are known, these are typically divided into two categories: plantable and compostable. Plantable pots are designed to be directly buried into the soil with the plant to degrade in the soil. This differs to compostable pots which require removal of the plant from the pot, as the pots are not designed to biodegrade in the soil. The vast majority of the compostable pots are only compostable within an industrial compost facility.

Biodegradable plantable pots are typically made from fibrous/fibre-based materials, however a disadvantage with these pots is the reduced mechanical/structural strength or stiffness of the container, which does not survive the rigours of a nursery leading to early degradation prior to plant growth being sufficient to pass on for sale. Additionally, the cost to manufacture and the cost to the nursery for those pots that can survive the growing period makes them uneconomic for mass use in plant nurseries.

### OBJECT OF THE INVENTION

It is an object of the invention to provide an improved plant container or tray that at least overcomes some of the disadvantages mentioned above.

Alternatively, or in addition, it may be an object of the invention to provide the public with a useful choice.

### SUMMARY OF THE INVENTION

According to a first aspect of the invention, there is provided a container or tray that is configured to biodegrade after a predetermined period of time when the container has been planted.

In one embodiment, the container is adapted to substantially biodegrade within 12 months of being planted underground. Preferably, the container is adapted to substantially biodegrade within 6-12 months of being planted underground.

In a preferred embodiment, the container may be configured to fully biodegrade within 24 months of being planted. More preferably, the container is adapted to fully biodegrade within 18-24 months of being planted underground.

In another embodiment, the container is composed of a composition that includes at least one filler adapted to provide mechanical stiffness to the container during the growing phase and/or provide one or more nutrient(s) to soil upon degradation of the container.

In a further embodiment, the filler is adapted to enhance the degradation of the composition.

In one embodiment, the filler comprises processed organic matter. In such an embodiment, the filler may include processed animal matter. Animal matter may be sourced from land or marine species. In some embodiments, the animal matter may include biological matter obtained from slaughterhouses, for example blood and bone matter. More preferably, the biological matter includes animal carcasses.

According to another aspect of the invention, there is provided a biodegradable composition for use as a container for plants, the composition comprising at least one polymer and at least one filler.

Preferably the at least one polymer is selected from Polybutylene succinate (PBS), Polylactic acid (PLA), Polyhydroxyalkanoates (PHA), Polyhydroxyalkanoates (PHB), Poly(3-hydroxybutyrate-co-3-hydroxyvalerate) (PHBV) and/or combinations thereof.

In one embodiment, the at least one polymer is a biobased or partially biobased polymer.

More preferably, the composition comprises a combination of polymers including PBS and PLA.

Preferably the at least one filler is configured to provide mechanical stiffness to the composition and/or provide one or more nutrient(s) to soil during degradation of the composition.

In a further embodiment, the filler is adapted to enhance the degradation of the composition.

Preferably the filler is selected from fertiliser, soil conditioners, soil enriching agents, weed suppressant and/or a combination thereof.

In one embodiment, the filler may comprise processed organic matter. In such an embodiment, the filler may include processed animal matter. Animal matter may be sourced from land or marine species. In some embodiments, the filler may include processed biological matter obtained from an animal, for example blood and bone matter. More preferably, the biological matter comprises animal carcass.

According to a further aspect of the invention, there is provided a use of a filler in a biodegradable composition for use in a biodegradable plant container, wherein the filler is configured to provide mechanical stiffness to the container during the growing phase of a plant above ground and/or provide at least one nutrient(s) to soil upon degradation of the plant container.

In one embodiment, the filler comprises processed organic matter. In such an embodiment, the filler may include processed animal matter. Animal matter may be sourced from land or marine species. In some embodiments, the animal matter may include biological matter obtained from slaughterhouses, for example blood and bone matter. More preferably, the biological matter comprises animal carcass.

In a further embodiment, the filler is adapted to enhance the degradation of the composition.

According to another aspect of the invention, there is provided a biodegradable composition, comprising Polybutylene succinate (PBS), Polylactic acid (PLA), and at least one filler adapted to provide at least one nutrient to soil.

Preferably the filler is selected from fertiliser, soil conditioners, soil enriching agents, weed suppressant and/or a combination thereof.

In one embodiment, the filler comprises processed organic matter. In such an embodiment, the filler may include processed biological matter obtained from slaughterhouses, for example blood and bone matter. More preferably, the biological matter comprises animal carcass.

In further aspect of the invention, there is provided an improved biodegradable composition including PLA and at least one filler, wherein the composition is adapted to degrade by at least 60% within 60 days.

In one embodiment, the filler comprises processed organic matter.

In a further embodiment, the filler is adapted to enhance the degradation of the composition.

In such an embodiment, the filler may include processed animal matter. Animal matter may be sourced from land or marine species. In some embodiments, the processed animal matter may include biological matter obtained from slaughterhouses, for example blood and bone matter. More preferably, the biological matter comprises animal carcass.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a front view of a plant container in accordance with one embodiment of the present invention.

FIG. 2 is a bottom view of a plant container in accordance with one embodiment of the present invention.

FIG. 3 is a cross-sectional view of a plant container in accordance with one embodiment of the present invention.

FIG. 4 is an exploded view of section “B” as shown in FIG. 1.

FIG. 5 is a front view of one unit of a tray of individual plant containers in accordance with one embodiment of the present invention.

FIG. 6 is an exploded view of section “B” as shown in FIG. 5.

FIG. 7 is a photograph of a plant container “A” used in the above ground degradation trial at day 60.

FIG. 8 is a photograph of a plant container “A” used in the above ground degradation trial at day 60.

FIG. 9 is a photograph of a plant container “B” used in the above ground degradation trial at day 60.

FIG. 10 is a photograph of a plant container “A” used in the underground degradation trial after approximately 7 weeks.

FIG. 11 is a photograph of a plant container “A” used in the underground degradation trial after approximately 7 weeks.

FIG. 12 is a photograph of a plant container “B” used in the underground degradation trial after approximately 7 weeks.

FIG. 13 is a photograph of a plant container “B” used in the underground degradation trial after approximately 7 weeks.

### DETAILED DESCRIPTION OF PREFERRED EMBODIMENTS OF THE INVENTION

Aspects of the present invention are directed towards an improved biodegradable composition. In one aspect, there is provided a plant container or tray comprised of the improved biodegradable composition.

By way of exemplification only, aspects of the invention will be described with reference to a plant container/tray being formed from the degradable composition as one possible application of the composition. Other aspects of the invention are not limited to such an application. It will be appreciated by the person skilled in the art that the biodegradable composition as described herein is capable of being used in other applications such as packaging containers, nursery trays, trays for transporting packaged items, crates for storage or transport, milk crates and the like.

The biodegradable composition includes at least one polymer and at least one filler. The filler is configured to provide mechanical stiffness to the container during the growing phase of a plant above ground and alternatively or additionally provide at least one nutrient(s) to the soil upon degradation of the container in soil. In combination with at least one polymer that adds strength to the container, the overall mechanical integrity may be improved.

In one aspect, the at least one polymer is a biobased or partially biobased polymer.

It will be appreciated by the person skilled in the art that biobased polymers are plastics that are made fully, or partly, from biomass. Most biobased polymers are designed to be biodegraded, however in order to be biodegraded they may require the use of an industrial composting facility to biodegrade. Some may also be composted in home compost systems, however the length of time to biodegrade may be significantly increased.

Preferably, the biobased or partially biobased polymer may be selected from Polybutylene succinate (PBS), Poly Lactic Acid (PLA), Polyhydroxyalkanoates (PHA), Polyhydroxyalkanoates (PHB), Poly(3-hydroxybutyrate-co-3-hydroxyvalerate) (PHBV) and/or combinations thereof.

In one aspect, the filler is adapted to enhance the degradation of the biobased or partially biobased polymer(s).

Typically, the growing phase of the plant above ground lasts up to approximately 12 months depending on the plant matter growing. In some forms, the biodegradable container formed from the biodegradable composition of the present invention may be formulated to ensure that it does not degrade before the container is likely to be ready to be planted.

Preferably, the biodegradable container is adapted to substantially biodegrade within 12 months of being planted underground. More preferably, the container is adapted to substantially biodegrade within 6-12 months of being planted underground.

In a preferred embodiment, the container may be configured to fully biodegrade within 24 months of being planted. More preferably, the container is adapted to fully biodegrade within 18-24 months of being planted underground.

It has been surprisingly found that a plant container made of the biodegradable composition of the present invention maintains good mechanical stability and integrity during the growing phase of a plant in above ground degradation tests. It is believed that the use of the filler provides this advantage to the container. It is also envisaged that the use of a filler in the composition also provides nutrients to the soil upon degradation of the container in soil. It has also been surprisingly found that the filler greatly enhances the degradation of the composition.

It will be appreciated that this provides numerous benefits over other biodegradable compositions and/or plant containers which are known to have defective mechanical stability and/or are prone to undesirable premature degradation when grown above ground for any period of time.

Without wishing to be bound by theory, it is believed the combination of the at least one polymer(s) and filler provides these benefits.

Additionally, it has been found by the inventors that the addition of a filler also provides improved manufacturability, namely during the extrusion/thermoforming process. It has been found the addition of a filler raises the modulus of the composition to a preferred level to allow for improved processing.

The biodegradable containers/trays of the present invention are adapted to be either home compostable and/or soil biodegradable when planted into soil. Both home composability and soil biodegradability are low temperature, aerobic degradation mechanisms. The biodegradable composition has been carefully developed in order to satisfy these requirements.

It will be appreciated by the person skilled in the art that certain polymers such as PLA usually require elevated temperatures for degradation. In particular, it is generally known that PLA degrades most efficiently at temperatures around 55-60° C. This temperature range makes degradation in milder conditions, i.e. such as those of home compositing systems which typically range from 25-35° C., unsuitable.

The biodegradable composition of the present invention comprises at least one polymer and one filler.

In preferred embodiments, the polymer is a biobased or partially biobased polymer. Preferably, the biobased or partially biobased polymer may be selected from Polybutylene succinate (PBS), Poly Lactic Acid (PLA), Polyhydroxyalkanoates (PHA), Polyhydroxyalkanoates (PHB), Poly(3-hydroxybutyrate-co-3-hydroxyvalerate) (PHBV) and/or combinations thereof.

It will be appreciated that the other polymers may be selected or used with the present invention. For example, it is envisioned that any polymers which are biodegradable can be used with the present invention.

In a preferred embodiment, the composition includes PBS. In one form, the composition may include PBS in an amount between 50-95% w/w of the composition, in another form the composition may include PBS in an amount between 60-90% w/w, or in a further form, the composition may include PBS in an amount between 80-90% w/w of the composition.

PBS is a thermoplastic polymer resin of the polyester family. PBS is a biodegradable aliphatic polyester with properties that are comparable to polypropylene. PBS is a relatively soft material and decomposes naturally into water and CO₂ and is therefore a suitable material for use in the plant containers of the present invention. However, the softness of the material may be problematic in the processing/handling above ground and particularly during manufacturing when used alone.

In a preferred form, the composition may comprise a blend of PBS and PLA. In one form, the composition may comprise more PBS than PLA. In a preferred form in a ratio of approximately 3:1 to 1:1, more preferably 2.5:1 to 1.5:1, or more preferably 2:1.

PLA is a thermoplastic polyester and largely made from renewable resources. Contrary to other thermoplastics which are petroleum-based, some of the raw materials used for PLA's production include corn starch, tapioca roots, or sugarcane. PLA is bio-based and biodegradable under certain conditions. However, without controlled composting conditions, i.e. commercial industrial composting facilities, it can take anywhere between 100 to 1000 years to decompose.

In some embodiments, the composition includes a filler. The filler is configured to provide mechanical stiffness to the composition, particularly when used to form a container. The degree of mechanical stiffness will depend on the intended use of the composition. In the case of a container, for example, the container is required to have enough stiffness to maintain its form as a container and to hold its intended load for the intended duration. For example, a plant pot needs to be strong enough to hold soil and plant for several months. Alternatively, or additionally, the filler may provide at least one nutrient(s) to the soil upon degradation of the composition in soil. The filler may also be adapted to enhance the degradation of the composition.

Without wishing to be bound by theory, it is believed the combination of the blend of polymers, in particular PLA and PBS, with a filler provides the added advantage of the composition having improved mechanical properties such as stiffness and strength. In general, it is believed that PLA alone is a brittle substance. The inclusion of a filler such as the types described herein in a polymer blend of PLA and PBS has surprisingly produced a composition having improved mechanical strength and stiffness. Fillers of the types described herein are considered to contribute stiffness to a product made from the composition, but may slightly reduce strength (e.g. tensile strength, impact strength). The use of PBS is considered to add strength. In addition, combined with the improved biodegradation properties, it should be appreciated that the composition of the present invention make it well suited for a variety of different applications.

The filler may be selected from fertilisers, soil conditioners, soil enriching agents, weed suppressants and/or a combination thereof. In one form, the filler is present in an amount between 0.01-15% w/w of the composition, more preferably in an amount between 1-15%, more preferably in an amount between 5-15%, or more preferably at least 10% w/w of the composition.

In a preferred embodiment, the filler comprises processed organic matter. In such an embodiment, the filler may include processed animal matter. Animal matter may be sourced from land or marine species. In some embodiments, the processed animal matter may include biological matter obtained from an animal, for example blood and bone matter or animal carcasses. Such matter is typically obtained as a by-product from the slaughter of animals for consumption. These by products may be cooked before being processed/milled into a fine powder, for example. Particularly preferred fillers include “Tui Blood & Bone Fertiliser” as marketed and sold by Tui Products Ltd or “Fish Meal” as marketed and sold by Fertile Fields. These products are stated to provide a natural source of nitrogen and phosphorous to soil. It is envisaged that other similar types of products may be used as a filler with the present invention.

In other embodiments, the processed animal matter may include animal faeces or manure.

In one embodiment, the composition includes only a single filler.

It is further envisaged that the use of such filler(s) may impart beneficial nutrient(s) to the soil upon degradation of the composition underground. It is believed the use of such fillers may provide at least one nutrient(s) to the soil upon degradation and/or promote healthy plant growth and conditioning to soil.

It will be appreciated by the person skilled in the art that other suitable fillers may be used with the present invention. For example, preferred processed fillers may be used which have small particle size, thermostability, degradable and offer nutrients. One such example may include the use of known fertilisers including a combination of N, P, K fertiliser at various ranges. It is envisaged that any suitable fertiliser may be used.

In one embodiment, the composition includes PBS, PLA and at least one filler. In one form, the filler is present in an amount between 0.01-15% w/w of the composition, more preferably in an amount between 1-15%, more preferably in an amount between 5-15%, or more preferably up to 10% w/w of the composition.

In a preferred form, the composition includes PBS, PLA and at least one filler in a ratio of approximately 6:3:1 (w/w).

It will be appreciated by the person skilled in the art that the ranges and components may be varied to suit the desired properties of the plant container. For example, the amount of PLA in the composition can be increased as desired to produce more stiffness in the final composition. Increasing the stiffness of the composition would lead to a more rigid (although possibly more brittle) product and lead to further control of the degradation time for the plant container. Additionally, the amount of filler may be varied to adjust the desired modulus of the composition for processing. It may also be used to control the amount of nutrient(s) provided to the soil upon degradation of the composition.

The inventors prepared a number of compositions, using a number of different fillers. Each were found to have varying results on the final composition. However, it was found that using a filler as described above resulted in a final composition having the desired advantages of maintaining good mechanical stability and integrity of plant container. This is discussed in further detail below.

Container Configuration

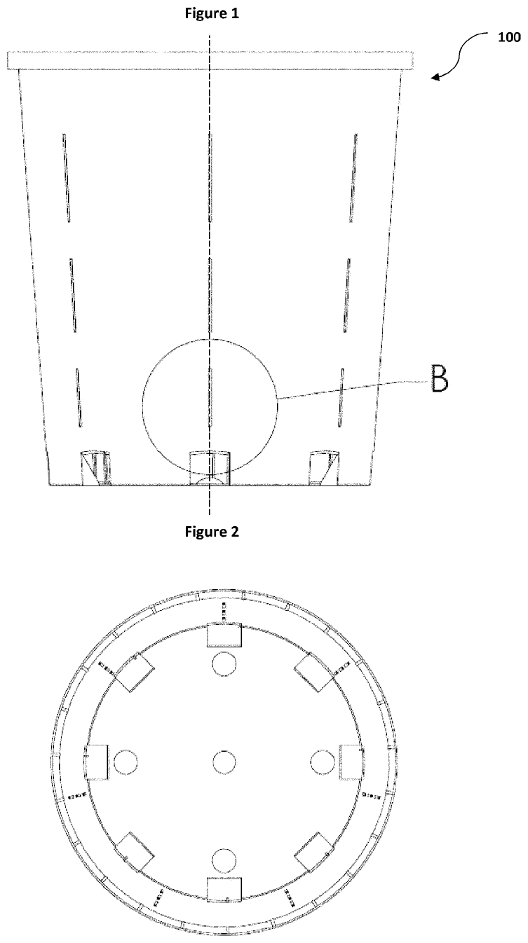

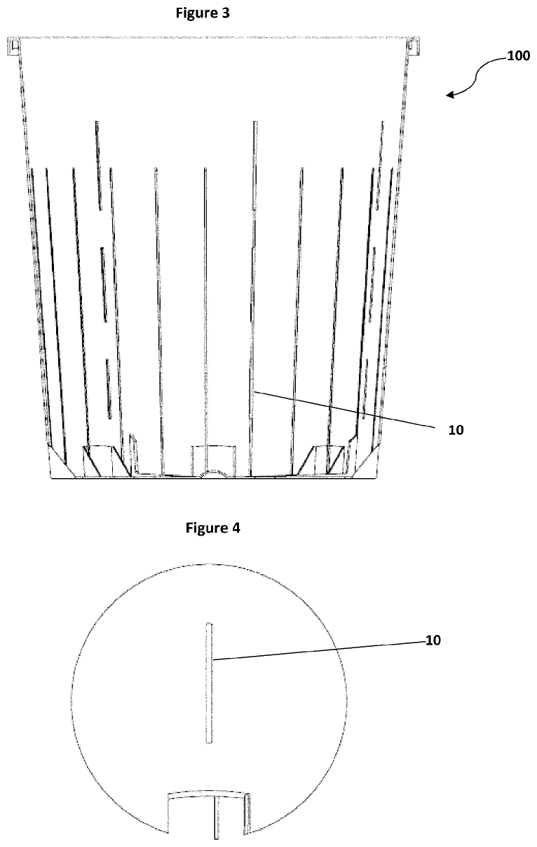

It will be appreciated by the person skilled in the art that the shape and/or configuration of the plant container may be adapted to facilitate growth of the plant and/or enhance degradation of the container once planted underground. For example, with reference to FIGS. 1-4, a plant container (100) is provided. The container (100) includes drain holes (20) on a base portion of the container to allow excess water to drain away. The drain holes are substantially circular in nature; however it will be appreciated that these holes should not be limited as such and any shaped holes can be used with the containers of the present invention.

The container (100) may include a series of elongated slits (10) around the outer circumference of the container. The slits generally extend vertically from the base portion of the container and may vary in size in terms of length and width of the slits. The slits (10) are configured to enable the root system of the plant to penetrate through the walls of the container once the container is planted underground. Additionally, the slits provide segments in which to allow the container to break down once it has been planted to further speed up degradation.

It will be appreciated that the number, size and location of the slits may vary depending on the size of the container. However, it will be noted that the container will be configured to retain soil and the plant within the container.

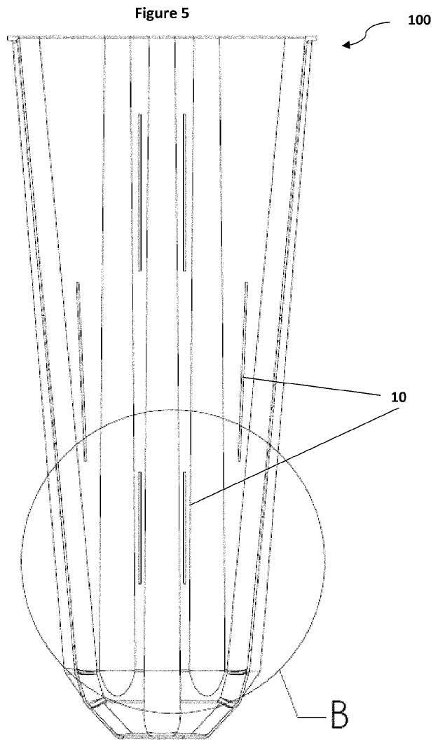

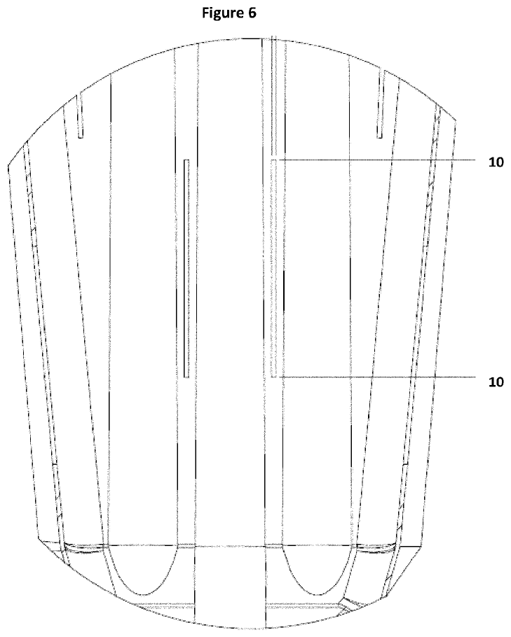

An alternative plant container/tray is also shown in FIGS. 5-6. Aspects of the container are similar to those of the plant container described above, therefore like references refer to like components.

### EXAMPLES

This present invention will now be described by reference to the following compositions prepared for use in a plant container. However, such examples should not be seen as limiting on the scope of the present invention.

### Example 1

| | Amount | |
|---|---|---|
| | (w/w %) | Comments |
| PBS | 90 | |
| Filler - | 10 | Commercial product “blood and |
| Fertiliser | | bone” by Tui used in this example. |

### Example 2

| | Amount | |
|---|---|---|
| | (w/w %) | Comments |
| PBS | 60 | |
| PLA | 30 | |
| Filler | 10 | Commercial product “blood and |
| | | bone” fertiliser used in this example. |

### Example 3

| | Amount | |
|---|---|---|
| | (w/w %) | Comments |
| PBS | 60 | |
| PLA | 30 | |
| Filler | 10 | Commercial grade |
| | | Sheep pellets (ground) |

### Example 4

| | Amount | |
|---|---|---|
| | (w/w %) | Comments |
| PBS | 60 | |
| PLA | 30 | |
| Filler | 10 | Starch |

### Example 5

| | Amount | |
|---|---|---|
| | (w/w %) | Comments |
| PBS | 60 | |
| PLA | 30 | |
| Filler | 10 | Kiwifruit ‘hair’ - |
| | | cyclone dust |

### Example 6

| | Amount | Comments |
|---|---|---|
| | (w/w %) | |
| PBS | 60 | |
| PLA | 30 | |
| Filler | 10 | Sanderdust - a form |
| | | of sawdust. |

### Example 7A

Composition was manufactured into a sample
using a thermoforming process.
A sample of this composition was used
for in home biodegradation testing.

| | Amount (w/w %) | Comments |
|---|---|---|
| PBS | 75 | |
| PLA | 15 | |
| Filler | 10 | Commercial product “blood |
| | | and bone” fertiliser |
| | | used in this example. |

### Example 7B

Composition was manufactured into a sample
using an injection moulding process.
A sample of this composition was used
for in home biodegradation testing.

| | Amount (w/w %) | Comments |
|---|---|---|
| PBS | 75 | |
| PLA | 15 | |
| Filler | 10 | Commercial product “blood |
| | | and bone” fertiliser |
| | | used in this example. |

### Example 8A

Composition was manufactured into a sample
using a thermoforming process.
A sample of this composition was used
for in home biodegradation testing.

| | Amount (w/w %) | Comments |
|---|---|---|
| PBS | 45 | |
| PLA | 45 | |
| Filler | 10 | Commercial product “blood |
| | | and bone” fertiliser |
| | | used in this example. |

### Example 8B

Composition was manufactured into a sample
using an injection moulding process.
A sample of this composition was used
for in home biodegradation testing.

| | Amount (w/w %) | Comments |
|---|---|---|
| PBS | 45 | |
| PLA | 45 | |
| Filler | 10 | Commercial product “blood |
| | | and bone” fertiliser |
| | | used in this example. |

### Example 8C

Composition was manufactured into a sample
using an injection moulding process.
A sample of this composition was used
for in home biodegradation testing.

| | Amount (w/w %) | Comments |
|---|---|---|
| PBS | 45 | |
| PLA | 45 | |
| Filler | 10 | Starch |

### Example 8D

Composition was manufactured into a sample
using an injection moulding process.
A sample of this composition was used
for in home biodegradation testing.

| | Amount (w/w %) | Comments |
|---|---|---|
| PBS | 45 | |
| PLA | 45 | |
| Filler | 10 | Commercial product “fish- |
| | | meal” fertiliser |
| | | used in this example. |

### Example 9A

Composition was manufactured into a sample
using a thermoforming process.
A sample of this composition was used
for in home biodegradation testing.

| | Amount (w/w %) | Comments |
|---|---|---|
| PBS | 30 | |
| PLA | 60 | |
| Filler | 10 | Commercial product “blood |
| | | and bone” fertiliser |
| | | used in this example. |

### Example 9B

Composition was manufactured into a sample
using an injection moulding process.
A sample of this composition was used
for in home biodegradation testing.

| | Amount (w/w %) | Comments |
|---|---|---|
| PBS | 30 | |
| PLA | 60 | |
| Filler | 10 | Commercial product “blood |
| | | and bone” fertiliser |
| | | used in this example. |

Method of Manufacture

Forming the container may occur using any technique as known to one skilled in the art. For instance, the composition of the present invention may be extruded into a desired container defining a cavity. Alternatively, an additive layering manufacturing process could also be used to build the shape of a container defining a cavity. It is also envisaged that a moulding process could be used e.g. a sacrificial moulding or injection moulding process or thermoforming.

Reference will be made to an extrusion/thermoforming method for preparing the container. However, this should not be seen as being limited on the scope present invention. It will be appreciated by the person skilled in the art that other methods for the manufacture of the containers may be used.

In accordance with the present invention, the composition is processed through extrusion using a twin-screw extruder in order to reduce the production cost by process simplification, and to minimize the degradation of physical properties following the addition of a filler such as starch. The compositions were prepared using standard extrusion equipment—Labtech 26 mm scientific twin-screw, co-rotating extruder, LTE26-40.

A mixture of the polymer and filler were extruded into sheets using co-rotating extruder (LTE26-40, 40L/D ratio) set up with a slit die and a LabTech roller calendar. The die pressure was set between 25-35 Bars.

The sheets were collected as rolls from the extruder and then stored prior to thermoforming.

3D printed moulds of plant trays were prepared for the thermoforming step. The extruded sheet was then subsequently thermoformed using standard vacuum former equipment (Steele FS44).

In order to allow the vacuum to penetrate through the mould, a series of vent holes were drilled into the moulds.

The extruded sheets were then thermoformed over the mould. The sheets were heated until soft, and placed over the moulds to form the containers.

Initial testing indicated that examples 1 and 2 had the necessary attributes so that they were able to be thermoformed.

Examples 1 and 2 above where able to be injection moulded and became “pot A” and “pot B” referred under in-home degradation tests below.

Injection Moulding

Additional compositions with injection moulding grade material (examples 7B, 8B-8D and 9B described above) were also manufactured into individual pots by injection moulding. This was successful and two separate pots were produced and considered suitable for mass production.

The testing involved developing five injection moulding compositions (examples 7B, 8B-8D and 9B), having varying percentages of PBS and PLA using specific injection moulding grades and incorporated using two different fillers in the process, one with “fishmeal” and one with “blood and bone”.

Of the five compositions prepared above, examples 7B and 8D were considered to be commercially viable of production by injection moulding.

It should be appreciated by the person skilled in the art that different grades of starting materials may be used depending on the method of manufacture. For example, the grade of PLA, PBS or filler may be altered according to the method of manufacture utilised.

Degradation Trial

A plant container prepared in accordance with the present invention was used in this trial. A plant container was composed using compositions disclosed in examples 1 and 2.

The purpose of the trial was to compare the rate and type of breakdown of the plant container of the present invention under ‘normal’ in use conditions.

Both above ground and below ground trials were conducted. The trials were conducted during New Zealand spring time conditions (from September to November).

It will be appreciated that commercial plant nurseries are generally very wet environments. It is believed that this additional moisture may have contributed to a faster degradation of the containers in this trial.

Trial 1—Commercial Nursery

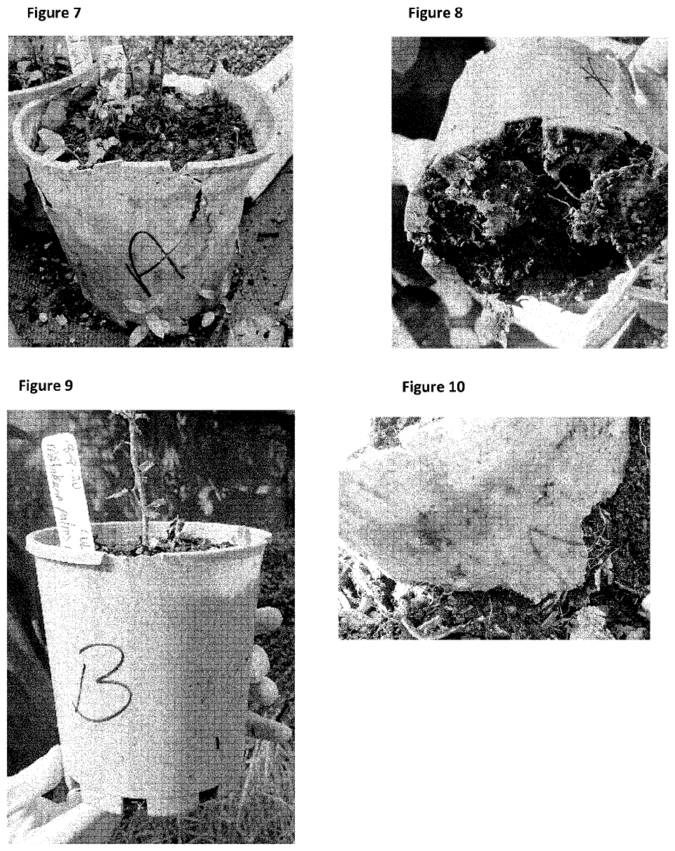

Two separate compositions were trialled in an above ground commercial nursery environment. FIGS. 7-9 show degradation of the containers after approximately 60 days of use.

As can be seen in FIGS. 7-8, in the trials, containers prepared from composition Example 1 showed visual signs of degradation after 60 days. This suggests the composition may be useful for plants with shorter growth times above ground.

With reference to FIG. 9, containers prepared from composition Example 2 showed minimal visual biodegradation after 60 days. This suggest that this composition may be suitable for plants having longer growth times above ground.

An additional sample was sent to a testing facility around approximately the same time for further detailed testing of biodegradation. It was noted at the time that no signs of degradation were evident after 60 days. It is believed the conditions in the testing facility are more controlled than that of a commercial nursery.

Trial 2—In Home/Underground Trial

An in-home, under-ground trial was conducted. Tomato seedlings were planted in both containers prepared from composition Examples 1 and 2, and both containers were subsequently planted.

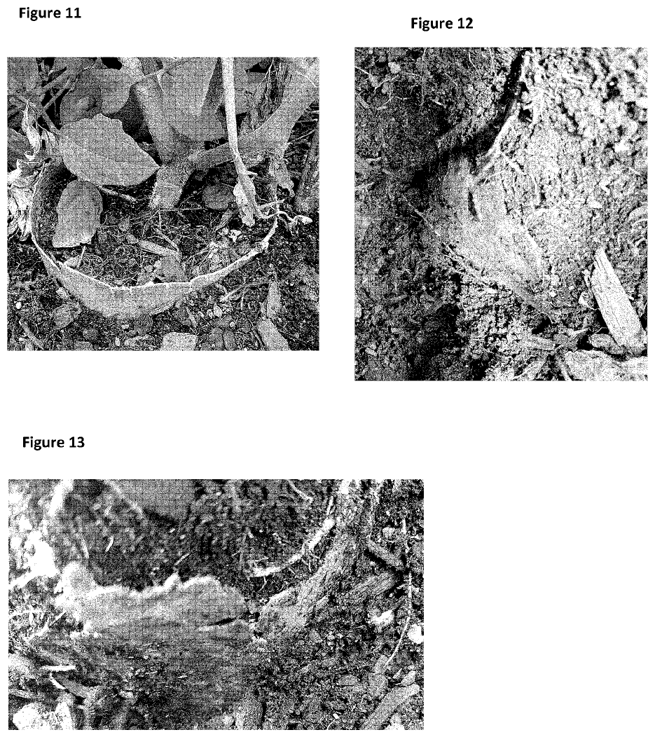

FIGS. 10-11 show the degradation of containers prepared from composition Example 1 after approximately 7 weeks underground.

FIGS. 12-13 show the degradation of containers prepared from composition Example 2 after approximately 7 weeks underground.

In the underground trials, upon visual inspection, both containers showed good degradation after just 42 days of planting underground.

At this stage, soil testing was yet to be conducted from this trial, however, from an initial observation of the plants, it was observed that plant growth was positive, and the plant matter appeared to be generally healthy. Growth characteristics of the plant planted underground with the container of the present invention was observed to be improved overall from that of previous plants.

Trial 3—Biodegradation trial

As noted in trial 1, samples were sent to a laboratory testing facility (Scion, Titokorangi Drive, Rotorua 3046, New Zealand) for detailed testing to determine biodegradation of the samples. Three samples were tested in accordance with AS 5810 at 25°C.—the standard for testing at home composting conditions.

The testing facility conducted aerobic biodegradation testing of sample materials in activated vermiculite under home composting conditions at 25° C. according to ISO standard 14855-1 (2012).

Two different compositions with different fillers were tested in combination with a control sample. The two compositions included a polymer blend of PBS and PLA with different fillers comprising starch (sample 1) and blood and bone (sample 2) respectively. The control sample consisted of a mixture of PBS and PLA. Testing of each sample was conducted in triplicate with averages calculated from each sample, the results are as shown in table 1 and 2 below.

The biodegradation test passed the 10-day and 45-day validation requirement, as outlined in ISO 14855-1 (2012), indicating the microbial activity of the composting inoculum is satisfactory.

TABLE 1
Interim biodegradation percentage after 58 days
at 25° C. (average from three replicates).

| | Composition | Interim | Standard error |
|---|---|---|---|
| Test material | (wt %) | biodegradation (%) | (%) |
| Cellulose (reference) | 100% | 75.6 | 1.7 |
| PBS-PLA (control) | 65%-35% | 1.7 | 0.4 |
| PBS-PLA-Starch | 60%-30%-10% | 4.0 | 0.2 |
| (example 4) | | | |
| PBS-PLA-Blood and | 60%-30%-10% | 64.2 | 3.6 |
| Bone (example 2) | | | |

TABLE 2
Interim biodegradation percentage after 112
days at 25° C. (average from three replicates).

| | | Interim | Standard |
|---|---|---|---|
| | Composition | biodegradation | error |
| Test material | (wt %) | (%) | (%) |
| Cellulose (reference) | 100% | 79.6 | 1.8 |
| PBS-PLA (control) | 65%-35% | 2.8 | 1.0 |
| PBS-PLA-Starch | 60%-30%-10% | 6.8 | .05 |
| (example 4) | | | |
| PBS-PLA-Blood and | 60%-30%-10% | 75.9 | 2.2 |
| Bone (example 2) | | | |

As can be seen, the biodegradable composition of the present invention showed vast improvement in biodegradation over that of the control, in particular the results demonstrate the level of biodegradation of the biodegradable composition of the present invention was at least double the biodegradation of the control sample, while the composition containing blood and bone filler degraded 38 times faster than the control sample.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”. Conversely, the term “consists” or “consisting of” and the like are to be construed in an exclusive or exhaustive sense, that is to say, in the sense of “being limited to”. The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A biodegradable composition including:
a. At least one biobased or partially biobased polymer; and
b. At least one filler comprising processed organic matter;
wherein the filler is adapted to provide mechanical stiffness to the composition and/or provide one or more nutrient(s) to soil upon degradation of the composition in soil.

2. The composition as claimed in claim 1, wherein the at least one biobased or partially biobased polymer is selected from: Polybutylene succinate (PBS), Polylactic acid (PLA), Polyhydroxyalkanoates (PHA), Polyhydroxyalkanoates (PHB), Poly(3-hydroxybutyrate-co-3-hydroxyvalerate) (PHBV) and/or combinations thereof.

3. The composition as claimed in claim 1, wherein the at least one biobased or partially biobased polymer comprises a combination of polymers including PBS and PLA.

4. The composition as claimed in claim 1, wherein the filler includes processed organic matter obtained from animal matter.

5. (canceled)

6. A biodegradable composition including PLA and at least one filler obtained from processed organic matter, wherein the composition is adapted to degrade by at least 60% within 60 days under AS 5810 conditions.

7. The composition as claimed in claim 6, wherein the processed organic matter is derived from biological sources including animal carcasses.

8. The composition as claimed claim 6, further including PBS.

9. The composition as claimed claim 1, wherein the filler is present in an amount of 1-15% w/w of the composition.

10. The composition as claimed in claim 1, including at least 10% w/w of the filler.

11. (canceled)

12. The composition as claimed in claim 1, wherein the filler is adapted to provide mechanical stiffness to the composition when in use and further provide one or more nutrient(s) to soil upon degradation of the composition in soil.

13. A biodegradable composition consisting of:
a. A biobased polymer blend of PBS and PLA; and
b. At least one filler.

14. The composition as claimed in claim 13, wherein the filler includes processed organic matter derived from animal matter.

15. (canceled)

16. (canceled)

17. The composition as claimed in claim 13, wherein the filler is present in an amount from 1-15% w/w.

18. The composition as claimed in claim 13, including at least 10% w/w of the filler.

19. (canceled)

20. (canceled)

21. A container formed from a composition as claimed in claim 1.
